(19) United States
(12) Patent Application Publication
(10) Pub. No.: US 2023/0053199 A1
(43) Pub. Date: Feb. 16, 2023

(54) SYSTEMS AND METHODS FOR VEHICLE INVENTORY CONTROL

(71) Applicant: Gordon*Howard Associates, Inc., Littleton, CO (US)

(72) Inventors: Todd M. GOODNIGHT, Temecula, CA (US); Thomas J. MIDDAUGH, Colleyville, TX (US); Christopher M. MACHECA, Centennial, CO (US)

(73) Assignee: Gordon*Howard Associates, Inc., Littleton, CO (US)

(21) Appl. No.: 17/884,316

(22) Filed: Aug. 9, 2022

Related U.S. Application Data
(60) Provisional application No. 63/231,556, filed on Aug. 10, 2021.

(51) Int. Cl. G06Q 10/08

(52) U.S. Cl. CPC G06Q 10/087; H04W 4/021

(57) ABSTRACT

Vehicle inventory control. At least one example is a computer-implemented method of vehicle inventory control, the method comprising: receiving parameters indicating a geo-fence to be established at a predetermined time; establishing the geo-fence at the predetermined time; disabling a resident vehicle identified on a predetermined list of vehicles, the resident vehicle within the geo-fence at the predetermined time; and refraining from disabling a non-resident vehicle identified on the predetermined list of vehicles that is outside the geo-fence at the predetermined time.

### CROSS-REFERENCE TO RELATED APPLICATIONS

This application claims the benefit of U.S. Prov. 63/231,556 filed Aug. 10, 2021 titled “Systems and Methods for Dealer Inventory Control.” The provisional application is incorporated by reference herein as if reproduced in full below.

### BACKGROUND

Large automobile dealerships may have many hundreds of vehicles to manage. Many vehicles reside on the sales lot, yet others may be off-site overnight for a variety of reasons, such as overnight test drives and repairs at an off-site repair shop (e.g., off-site body shop).

While many of the vehicles at an automobile dealership may be owned by the dealership, other vehicles, such as new vehicles, may be consigned by the vehicle manufacturer to the dealership for sale. In other cases, the automobile dealership may equitably own the vehicles, but a third-party lender may finance the inventory, and thus the third-party lender may have liens on the financed inventory. Regardless, automobile dealerships are generally large volume, small margin businesses, and loss of a vehicle by theft severely impacts both the automobile dealerships, the consignors, and/or the lenders.

Thus, any developments in inventory control given the vagaries of vehicle location of an automobile dealership would provide a competitive advantage in the marketplace.

### SUMMARY

Vehicle inventory control. One example is a computer-implemented method of vehicle inventory control, the method comprising: receiving parameters indicating a geo-fence to be established at a predetermined time; establishing the geo-fence at the predetermined time; disabling a resident vehicle identified on a predetermined list of vehicles, the resident vehicle within the geo-fence at the predetermined time; and refraining from disabling a non-resident vehicle identified on the predetermined list of vehicles that is outside the geo-fence at the predetermined time.

In the example method, receiving parameters may further comprise receiving parameters indicative of a duration of establishment of the geo-fence; and the example method may further comprise enabling the resident vehicle after the duration.

The example method may further comprise: determining the resident vehicle relocated outside the geo-fence; and sending an alert responsive to the resident vehicle being outside the geo-fence. Determining the resident vehicle is outside the geo-fence may further comprise determining by way of a computer system located at an operations center remote from the location of the geo-fence. Determining the resident vehicle relocated outside the geo-fence may further comprise determining by way of an onboard device mechanically and electrically coupled to the resident vehicle. Sending the alert may further comprise sending the alert to at least one selected from the group consisting of: an owner of the resident vehicle; a consignor of the resident vehicle; a holder of a lien against the resident vehicle; and a law enforcement officer.

The example method may further comprise: compiling a list of non-resident vehicles identified on the predetermined list of vehicles that are outside the geo-fence when the geo-fence is established; and sending the list to at least one selected from a group comprising: an owner of the non-resident vehicles; a consignor of the non-resident vehicles; and a holder of a lien against the non-resident vehicles.

Another example is a system comprising: a processor; a wireless interface coupled to the processor; and a memory coupled to the processor. The memory may store a program that, when executed by the processor, causes the processor to: receive parameters indicative of boundaries of a geo-fence to be established at repeating intervals and a predetermined time each day to establish the geo-fence; establish the geo-fence at the predetermined time; disable a resident vehicle identified on a predetermined list of vehicles, the resident vehicle within the geo-fence; and refrain from disabling a non-resident vehicle identified on the predetermined list of vehicles that is outside the geo-fence.

In the example system, when the processor receives the parameters, the program may further cause the processor to receive parameters indicative of a duration of establishment of the geo-fence; and wherein the program may further cause the processor to enable the resident vehicle after the duration.

In the example system, the program may further cause the processor to: determine the resident vehicle relocated outside the geo-fence; and send an alert responsive to the resident vehicle being outside the geo-fence. When the processor determines the resident vehicle is outside the geo-fence, the program may further cause the processor to: receive location data from an onboard device mechanically and electrically coupled to the resident vehicle; and determine from the location data and the parameters indicative of the boundaries of the geo-fence that the resident vehicle relocated outside the geo-fence. When the processor sends the alert, the program may further causes the processor to send the alert to at least one selected from the group consisting of: an owner of the resident vehicle; a consignor of the resident vehicle; a holder of a lien against the resident vehicle; and a law enforcement officer.

In the example system, the processor, the wireless interface, and the memory may be members of a controller of an onboard device mechanically and electrically coupled to the resident vehicle.

In the example system, the program may further cause the processor to: compile a list of non-resident vehicles identified on the predetermined list of vehicles that are outside the geo-fence when the geo-fence is established; and send the list to at least one selected from a group comprising: an owner of the non-resident vehicles; a consignor of the non-resident vehicles; and a holder of a lien against the non-resident vehicles.

Yet another example is a non-transitory computer-readable medium storing instructions that, when executed by a processor, cause the processor to: receive parameters indicative of boundaries of a geo-fence to be established at repeating intervals, the parameters indicative of a preset duration for each geo-fence, and the parameters indicative of a predetermined time each day to establish the geo-fence; establish the geo-fence at the predetermined time, the geo-fence established for the preset duration; disable a resident vehicle identified on a predetermined list of vehicles, the resident vehicle within the geo-fence at the predetermined time, and the resident vehicle disabled for the preset duration; and refrain from disabling a non-resident vehicle identified on the predetermined list of vehicles that is outside the geo-fence when the geo-fence is established.

In the example non-transitory computer-readable, when the processor receives the parameters, the instructions may further cause the processor to receive parameters indicative of a duration of establishment of the geo-fence; and wherein the instructions may further cause the processor to enable the resident vehicle after the duration.

In the example non-transitory computer-readable medium, the instructions may further cause the processor to: determine the resident vehicle relocated outside the geo-fence; and send an alert responsive to the resident vehicle being outside the geo-fence. When the processor determines the resident vehicle is outside the geo-fence, the instructions may further cause the processor to: receive location data from an onboard device mechanically and electrically coupled to the resident vehicle; and determine from the location data and the parameters indicative of the boundaries of the geo-fence that the resident vehicle relocated outside the geo-fence. When the processor sends the alert, the instructions may cause the processor to send the alert to at least one selected from a group consisting of: an owner of the resident vehicle; a consignor of the resident vehicle; a holder of a lien against the resident vehicle; and a law enforcement officer.

In the example non-transitory computer-readable medium, the instructions may further cause the processor to: compile a list of non-resident vehicles identified on the predetermined list of vehicles that are outside the geo-fence; and send the list to at least one selected from a group comprising: an owner of the non-resident vehicles; a consignor of the non-resident vehicles; and a holder of a lien against the non-resident vehicles.

Yet still another example is an onboard device configured to mechanically and electrically couple to a vehicle, the onboard device comprising: a controller; a relay defining a set of terminals and a control input, the control input coupled to the controller; a Global Positioning System receiver coupled to controller; and a wireless interface coupled to the controller. The controller may be configured to: receive parameters indicating boundaries of a geo-fence to be established; establish the geo-fence; disable the vehicle by asserting the control input of the relay if the vehicle is within the geo-fence; and refrain from disabling by holding the control input de-asserted if vehicle is outside the geo-fence.

In the example onboard device, when the controller receives the parameters, the controller may further receive the parameters indicative of repeating intervals for the geo-fence; and when the controller establishes the geo-fence, the controller may be further configured to establish the geo-fence at the repeating intervals.

In the example onboard device, when the controller disables the vehicle, the controller may be further configured to: determine the vehicle relocated outside the geo-fence; and send an alert responsive to the vehicle being outside the geo-fence.

### BRIEF DESCRIPTION OF THE DRAWINGS

For a detailed description of exemplary embodiments, reference will now be made to the accompanying drawings in which:

FIG. 1 shows, in block diagram form, a system in accordance with at least some embodiments;

FIG. 2A shows an overhead view of an established geo-fence in accordance with at least some embodiments;

FIG. 2B shows an overhead view of an established geo-fence in accordance with at least some embodiments;

FIG. 3 shows a flow chart for implementing the method in accordance with at least some embodiments;

FIG. 4 shows a flow chart for implementing the method in accordance with at least some embodiments; and

FIG. 5 shows a computer system in accordance with at least some embodiments.

### DEFINITIONS

Certain terms are used throughout the following description and claims to refer to particular system components. As one skilled in the art will appreciate, different companies may refer to a component and/or method by different names. This document does not intend to distinguish between components and/or methods that differ in name but not in function.

In the following discussion and in the claims, the terms “including” and “comprising” are used in an open-ended fashion, and thus should be interpreted to mean “including, but not limited to. . . . ” Also, the term “couple” or “couples” is intended to mean either an indirect or direct connection. Thus, if a first device couples to a second device that connection may be through a direct connection or through an indirect connection via other devices and connections.

“Controller” shall mean, alone or in combination, individual circuit components, an application specific integrated circuit (ASIC), a microcontroller with controlling software, a reduced-instruction-set computing (RISC) with controlling software, a digital signal processor (DSP), a processor with controlling software, a programmable logic device (PLD), a field programmable gate array (FPGA), or a programmable system-on-a-chop (PSOC), configured to read inputs and drive outputs responsive to the inputs.

“Disabling a . . . vehicle” shall mean rendering a vehicle unable to transition to a condition where the vehicle can be driven. For gasoline powered vehicles, the disabling may include rendering the internal combustion engine inoperable. For gas-electric hybrid vehicles and electric vehicles, disabling may include rendering the vehicle unable to transition out of a parked condition.

“Geo-fence” shall mean a virtual perimeter enclosing a geographic area.

“Remote” shall mean one kilometer or more.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various examples are directed to vehicle inventory control. More particularly, various examples are directed to establishing a geo-fence around a vehicle dealership each day at a predetermined time (e.g., closing time), and the geo-fence established for a preset duration (e.g., overnight until opening time the next morning). For vehicles identified on a vehicle inventory list, those vehicles within the geo-fence are disabled to prevent theft. The disablement prevents insider theft (e.g., thief has the keys to the vehicles after hours). Moreover, if at any point during the time the geo-fence is enabled the disabled vehicle relocates outside the geo-fence (e.g., unauthorized towing), an alert may be sent to appropriate authorities. Those vehicles from the vehicle inventor list that are outside the geo-fence at the time the geo-fence is established are not disabled. The various embodiments were developed in the context of a vehicles in the form of automobiles and other wheeled vehicles, and the description that follows is based on the developmental context. However, the various examples are applicable outside of automobiles and other wheeled vehicles, to include other vehicles such as boats, personal watercraft, and airplanes. Thus, the developmental context shall not be read as a limitation. The specification first turns to a high level system overview.

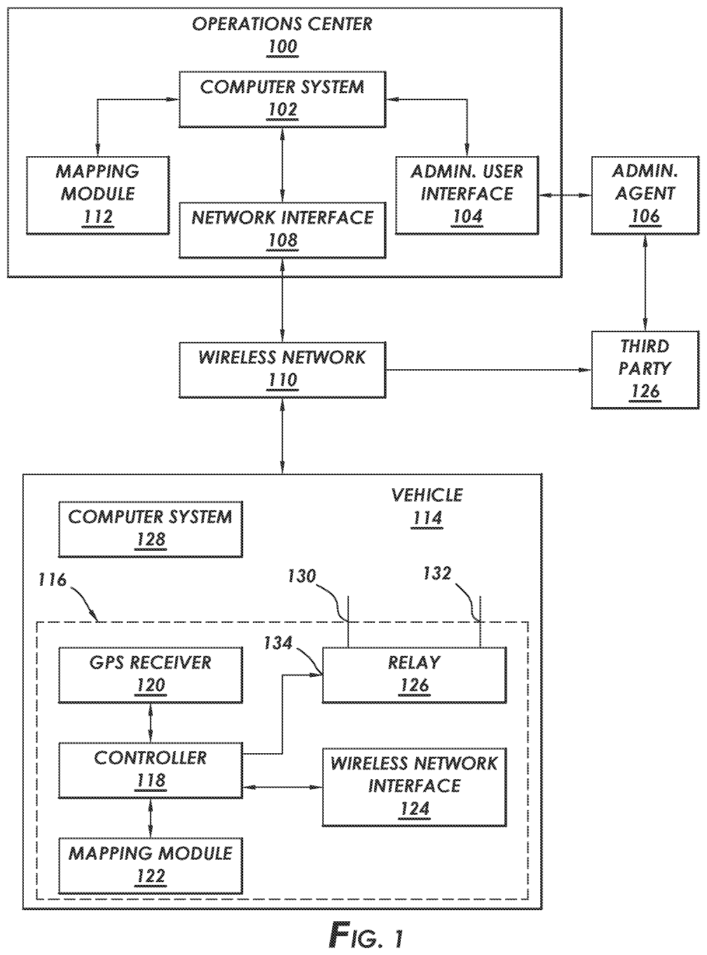

FIG. 1 shows, in block diagram form, an example system. In particular, the system comprises an operations center 100 communicatively coupled to a vehicle 114 by way of a wireless network 110. The operations center 100 comprises a server or computer system 102. In some embodiments, the computer system 102 may be a stand-alone computer system, or may be a plurality of computer systems communicatively coupled and performing the functions of the operations center 100, the functions discussed more thoroughly below. The computer system 102 may couple to an administrative user interface 104. The administrative user interface 104 may enable an administrative agent 106 to control or configure the operation of the system, such receiving parameters indicating a geo-fence to be established at repeating intervals, the parameters indicating a preset duration for each geo-fence, and the parameters indicating a predetermined time each day to establish the geo-fence. Moreover, the administrative user interface 104 may enable the administrative agent 106 to provide a predetermined list of vehicles associated with an automobile dealership. The administrative user interface 104 may be a standalone computer system executing appropriate programs, a server in a rack of servers executing appropriate programs, or programs executing within the computer system 102.

In one example, in order to communicate with the vehicle 114, the operations center 100 may further comprise a network interface 108 communicatively coupled to the computer system 102. By way of the network interface 108, the computer system 102, and any programs executing thereon, may communicate with the vehicle 114, such as by wireless network 110. Wireless network 110 is illustrative of any suitable communications network, such as local-area network, a wide-area network, the Internet, a 5G cellular network, or other system for transmitting information between the operations center 100 and the vehicle 114. In example systems, the operations center 100 is remotely located from the vehicle 114. While in some cases the operations center 100 and vehicle 114 may be located within the same city or state, in other cases the operations center 100 may be many hundreds or thousands of miles from the vehicle 114, and thus the illustrative wireless network 110 may span several different types of communication networks (e.g., from a local-area network to an internet service provider, and then to the Internet generally, and then to an entry node of a wireless 5G cellular network, then to the vehicle 114).

Still referring to FIG. 1, the example system further comprises the vehicle 114 communicatively coupled to the operations center 100 by way of the illustrative wireless network 110. In particular, the vehicle 114 may comprise an onboard device 116 mechanically and electrically coupled to the vehicle 114. In some cases, the onboard device 116 may be part of the vehicle 114 as purchased from the manufacturer (i.e., an original equipment manufacturer (OEM) device). In other cases, however, the onboard device 116 may be a third-party after-market system, such as a device installed by the dealership when the vehicle arrives.

Onboard device 116 may comprise a controller 118, a global-positioning system (GPS) receiver 120, a mapping module 122, a wireless network interface 124, and electrically-controlled switch or relay 126. The example controller 118 may comprise any device or set of devices that may implement the functionality of the onboard device 116. In one example, the controller 118 is a processor that communicates with subsystems of the vehicle, such as a computer system 128 of the vehicle 114. The onboard device 116 may be configured to communicatively couple by way of a connector (not specifically shown) to the onboard diagnostic two (OBD-II) port to read or determine data from the computer system 128 associated with the vehicle 114.

The example onboard device 116 further comprises the wireless network interface 124 communicatively coupled to the controller 118. By way of the wireless network interface 110, functionality executed by the controller 118 may communicate with other devices. In some embodiments, the wireless network interface 124 enables the controller 118 to communicate with operations center 100 by way of a wireless transmission through the wireless network 110. The wireless network interface 124 thus implements a wireless communication system and/or protocol, such as participating within a 5G cellular data network.

The onboard device 116 further comprises the GPS receiver 120 communicatively coupled to controller 118. The GPS receiver 120 receives signals from an array of GPS satellites orbiting the earth, and based on timing associated with arrival of those signals, a location of the onboard device 116 (and thus the vehicle 114) can be determined. In some cases, the GPS receiver 120 has sufficient functionality to calculate location internally, and thus the data passed to the controller 118 may be a direct indication of location. In other cases, the functionality to determine location may be shared between the GPS receiver 120 and computer system 102 of the operations center 100 by way of wireless network 110. That is, the GPS receiver 120 may receive the plurality of GPS signals and pass the information to a program on the computer system 102, which program may then make the determination as to location of the onboard device 116 and the vehicle 114. In still other cases, the controller 118 combined with information received by the GPS receiver 120 may make a determination as to the location of the onboard device 116.

In one example the onboard device 116 tracks the vehicle with high precision using the GPS receiver 120, and may be able to identify the street and block at which the vehicle is located at any given time (though the onboard device 116 may not necessarily have or contain street-level databases). In another example, location tracking may be accomplished by way of cellular signal triangulation. For example, the wireless network interface 124 may be a cellular transceiver implementing a wireless communication system and/or protocol (e.g., 5G cellular network).

In some cases, the location determined by or in associate with the onboard device 116 may only be a position on the face of the earth, for example, a latitude and a longitude. The mapping module 112, located at the operations center 100 and receiving a stream of locations from the onboard device 116, may correlate to streets and addresses or geo-fence boundaries. In other cases, the onboard device 116 may have sufficient memory and computing functionality to not only determine position in a latitude and longitude sense, but also to correlate the positions to cities, streets, addresses, and/or geo-fence boundaries. Thus, the onboard device 116 coupled to vehicle 114 may further comprise its own mapping module 122 communicatively coupled to the controller 118. In accordance with at least some embodiments, the mapping module 122 may be a computer program or program package that operates or executes on the controller 118 implemented as a processor or micro-controller to perform a mapping function associated with the location of vehicle 114 and any geo-fences boundaries.

The example relay 126 defines a first terminal 130, a second terminal 132, and a control input 134. The terminals 130 and 132 define relay contacts that are selectively closed or conductive, or open or non-conductive. The control input 134 is coupled to the controller 118. In one example, the relay is an electrically-operated mechanical relay. In other cases, the relay 126 may be solid-state relay with no moving mechanical components. In another example, the relay 126 may be a field-effect transistor operated as an electrically-controlled switch. In an example installation, a starter control wire (not specifically shown) associated with the starter solenoid for the vehicle 114 is cut, and the terminals 130 and 132 are coupled in series with the starter control wire. When the relay 126 is open or non-conductive, any start commands sent along the control wire are blocked by the relay 126. When the relay 126 is closed or conductive, any start commands sent along the control wire propagate through the relay and thus start the vehicle 114.

Many new automobiles implement a neutral safety switch. That is, most if not all new vehicles are designed and constructed such that the transmission cannot be moved out of the park setting and/or the engine cannot be cranked and started unless the brake pedal is pressed. A similar clutch safety switch may be implemented for manual transmission vehicles such that the engine cannot be cranked unless the clutch pedal is pressed. Thus, in yet another example installation of the onboard device 116, the control wire for the neutral safety switch or the clutch safety switch is cut, and the terminals 130 and 132 are coupled in series with the control wire. When the relay 126 is open or non-conductive, the automobile will not start for an apparent failure to press the brake and/or clutch. When the relay 126 is closed or conductive, the pressing of the brake and/or pressing of the clutch can be read and thus the vehicle 114 is allowed to start.

The specification now turns to a high level description of establishing a geo-fence, and actions taken responsive to the geo-fence as it relates to the automobile dealership's inventory. In particular, the automobile dealership generates parameters associated with a geo-fence to be created at repeating intervals, such as: the boundaries of the geo-fence (e.g., surrounding the physical location or locations of the automobile dealership); the start time each day of the geo-fence; and the end-time of the geo-fence or a preset duration of the geo-fence. Moreover, the automobile dealership creates a vehicle inventory list that includes all the vehicles to be tracked or accounted for, such as all the new and used inventory of vehicles of the automobile dealer.

In example cases, the geo-fence is established each evening at the predetermined time, such as after close of business each day. The geo-fence remains active until de-established, such as de-established at predetermined time the next business day, or de-established after a preset duration. At the time the geo-fence is established each day, a determination is made regarding the location of the vehicles identified by the vehicle inventory list. In example cases, all vehicles that reside within the geo-fence when the geo-fence is established are disabled, such as by having the relays 126 of their respective onboard device 116 open or become non-conductive. Vehicles that reside within the geo-fence may be referred to as resident vehicles for residing within the geo-fence. During periods of time that the geo-fence is established (e.g., overnight), locations of the resident vehicles continue to be periodically monitored. If a resident vehicle crosses the geo-fence or is otherwise located outside the geo-fence (e.g., theft by towing), an alert is sent to appropriate entities. The appropriate entities may include or any one or a combination of: an owner of the resident vehicle; a consignor of the resident vehicle; a holder of a lien against the resident vehicle; and a law enforcement officer.

Vehicles identified on the vehicle inventory list that reside outside the geo-fence when the geo-fence is established are not disabled. Vehicles that reside outside the geo-fence may be referred to as non-resident vehicles. In various examples, a list of the non-resident vehicles identified by the vehicle inventory list may be compiled, referred to as a non-resident list, and the list may be sent to appropriate entities. The appropriate entities may include or any one or a combination of: respective owners of the non-resident vehicles; respective consignors of the non-resident vehicles; and respective holders of liens against the non-resident vehicles.

Based on the parameters related to the geo-fence, the geo-fence may be disabled at the designated time and/or after the preset duration. For example, early in the morning on the next business day the geo-fence may be de-established, and all the resident vehicles may be enabled. The specification thus turns to a variety of different scenarios.

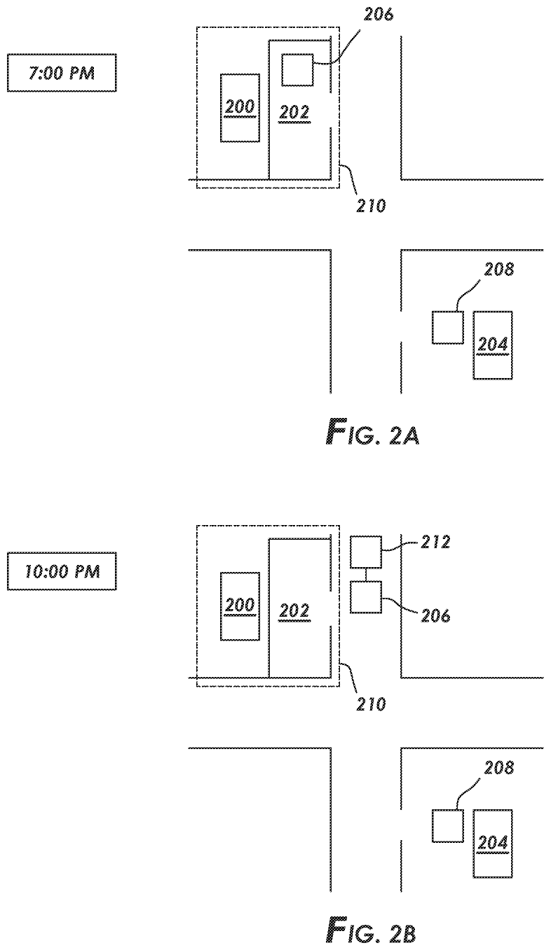

FIGS. 2A and 2B show, in block diagram form, example scenarios. Considering first Scenario 1 as illustrated by FIG. 2A. FIG. 2A shows an overhead view of a portion of a neighborhood. In this example, the neighborhood comprises an automobile dealership 200 having an associated inventory lot 202. The neighborhood also comprises an offsite third-party facility, such as body shop 204. In this example, the automobile dealership 200 may want to monitor vehicles in the inventory lot 202 after the close of business to prevent theft. Thus, the automobile dealership 200 may configure a geo-fence to encompass or encircle the inventory lot 202. The geo-fence may be configured to be automatically established at a predetermined time each evening, and to have a predetermined duration and/or until a predetermined end time the next business day. For example, the automobile dealership 200 may configure a geo-fence 210 around the inventory lot 202, with the geo-fence established between the close of business each day and when the automobile dealership opens the next business day (such as from 7:00 p.m. until 7:00 a.m.), to be repeated indefinitely until the configuration of the geo-fence is changed.

Further, in this example, two vehicles are shown, a vehicle 206 and a vehicle 208. Assume for purposes of discussion that the vehicles 206 and 208 are listed on a vehicle inventory list of the automobile dealership 200. At the establishment of the geo-fence (e.g., 7:00 PM), the system determines whether the vehicles 206 and 208 are located within the geo-fence 210. In the case of FIG. 2A, when the geo-fence 210 is established, the vehicle 206 is located within the geo-fence 210 and the vehicle 208 is located outside of the geo-fence at the body shop 204. During the time the geo-fence 210 is established, the resident vehicle 206 that is within the geo-fence 210 is disabled and cannot be started, and an enabled state of the non-resident vehicle 208 outside the geo-fence 210 remains unchanged. The non-resident vehicle 208 may still be driven, for example from the body shop 204 to the automobile dealership 200, while the geo-fence 210 is established. In one example, if the non-resident vehicle 208 is returned to the inventory lot 202 during the period of time the geo-fence 210 is established, once inside the geo-fence the status changes to resident vehicle, the vehicle 208 is disabled, and a message is sent to the operations center indicating a change of status.

Turning now to Scenario 2 of FIG. 2B. In Scenario 2, consider initially that the vehicle 206 is located on the inventory lot 202 when the geo-fence is established (e.g., 7:00 p.m.), and thus the vehicle 206 is disabled. However, subsequently a thief 212 may tow the vehicle 206 off the inventory lot 202 during the period of time the geo-fence is established. In this example, an alert is sent when the vehicle 206 departs the geo-fence. As such, if at any point during the duration that the geo-fence is established, if the vehicle 206 departs the geo-fence 210 an alert will be sent to the automobile dealership 200, and any other interested entities, indicating the vehicle relocated outside geo-fence during non-business hours.

Returning to FIG. 1. The implementation of the geo-fence, and the subsequent actions when a vehicle is within or outside the geo-fence, can take many suitable forms. The discussion starts with a case in which the operations center 100 is primarily responsible for establishing the geo-fence, monitoring vehicles with respect to the geo-fence, and taking subsequent actions. In the example, in the evening at the predetermined time, such as after close of business each day, the computer system 102 establishes the geo-fence. In the case of the operations center 100 establishing the geo-fence, the establishment may involve commencement of the computer system 102 comparing location information received from onboard device of vehicles identified on the vehicle inventory list to the boundaries of the geo-fence, such as by using the mapping module 112. For each vehicle residing within the geo-fence-the resident vehicles-the computer system 102 sends a command by way of the wireless network interface 108 to disable the resident vehicles. For each vehicle residing outside the geo-fence-the non-resident vehicles-the computer system 102 refrains from disabling non-resident vehicles.

During periods of time that the geo-fence is established (e.g., overnight), the computer system 102 continues to monitor location information received from the onboard devices of the resident vehicles. If the computer system 102 determines a resident vehicle crossed the geo-fence or is otherwise relocated outside the geo-fence (e.g., theft by towing), the computer system 102 sends an alert to the appropriate entities, such as by using the administrative user interface 104 or the network interface 108. The appropriate entities to which an alert is sent may include one or any combination of: an owner of the resident vehicle; a consignor of the resident vehicle; a holder of a lien against the resident vehicle; and a law enforcement officer.

Still considering periods of time when the geo-fence is established, the computer system 102 may compile a non-resident vehicle list, and the non-resident vehicle list may be sent to appropriate entities, such as by using the administrative user interface 104 or the network interface 108. Again, the appropriate entities may include one or any combination of: respective owners of the non-resident vehicles; respective consignors of the non-resident vehicles; and respective holders of liens against the non-resident vehicles.

Thus, in the example of the operations center 100 being primarily responsible for establishing the geo-fence and taking subsequent action, each onboard device may periodically send location information, in any suitable form, to the operations center 100, and enable/disable its attached vehicle when instructed. But otherwise the onboard devices need not be responsible for making determinations as to locations of the vehicles related to the geo-fence. In fact, in this example case the onboard devices need not even know the boundaries of the geo-fence or when the geo-fence is established.

Based on the parameters related to the geo-fence, the operations center 100 may disable the geo-fence at the designated time and/or after the preset duration. For example, early in the morning on the next business day the geo-fence may be de-established, and all the resident vehicles may be enabled.

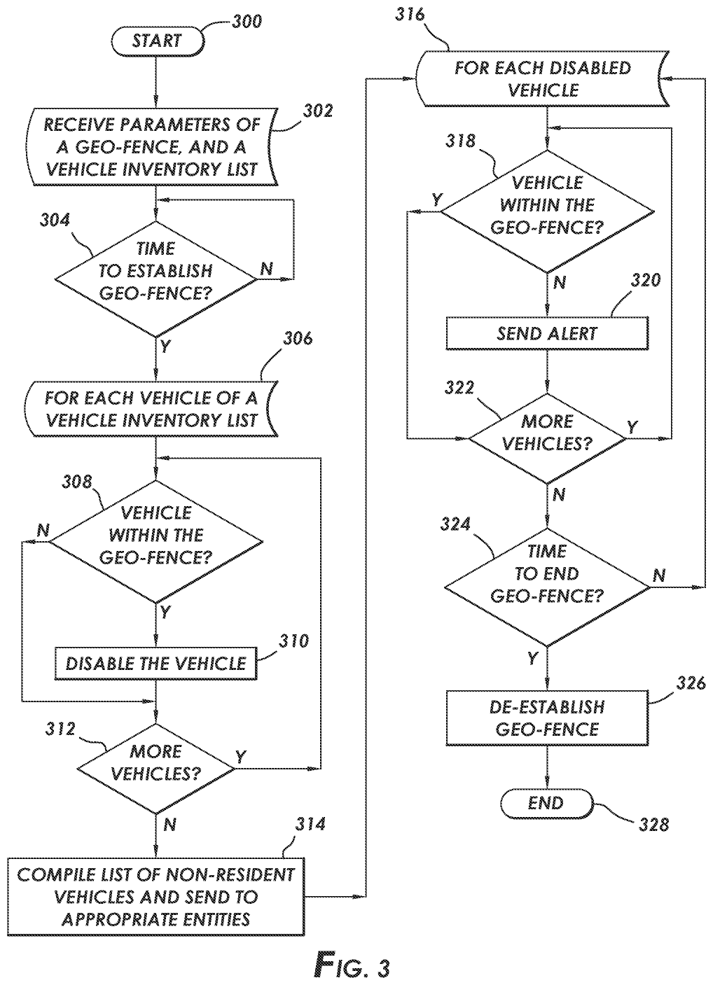

FIG. 3 shows an example flow chart for the case in which the operations center 100 (FIG. 1) is primarily responsible for establishing the geo-fence, monitoring vehicles with respect to the geo-fence, and taking subsequent actions. Thus, the process of FIG. 3 may be implemented by the computer system 102 (FIG. 1) of the operations center 100. In particular, the method starts (block 300), and comprises receiving parameters of a geo-fence, and receiving a vehicle inventory list (block 302). When receiving the parameters of the geo-fence, the example process may receive parameters indicating a geo-fence to be established at repeating intervals, a predetermined time each day to establish the geo-fence, and a preset duration or end time for the geo-fence.

The next example step is a determination as to whether the predetermined time to establish the geo-fence has arrived (block 304). If the time has not yet arrived (again block 304), the example process loops until the predetermined time. If the determination is that the predetermined time has arrived (again block 304), the example process moves to an analysis of the vehicles on the vehicle inventory list.

For each vehicle identified on the vehicle inventory list (block 306), the process determines whether the vehicle is within the geo-fence (block 308). If the vehicle is within the geo-fence, the vehicle is disabled (block 310), and a determination is made as to whether there are more vehicles on the vehicle inventory list (block 312). On the other hand, if the vehicle is outside the geo-fence (i.e., the no path out of block 308), the example process moves directly to the determination of whether there are more vehicles on the vehicle inventory list (again block 312). If there are more vehicles on the vehicle inventory list, the example process retreats to determining whether the next vehicle on the list is within the geo-fence (again block 308).

After the locating all the vehicles identified on the vehicle inventory, the next step in the example process is to compile a list of non-resident vehicles, and send the list to the appropriate entities (block 314). The balance of the example flow chart of FIG. 3 assumes that non-resident vehicles remain outside the geo-fence for the preset duration and/or until the predetermined time on the next business day, and thus the example flow chart does not include checking to determine whether non-resident vehicles return to be within the geo-fence. However, one having ordinary skill, and with the benefit of this disclosure, could modify flow chart to include checking for status change of non-resident vehicles to resident vehicles, and disabling same.

Still referring to FIG. 3, for each disabled vehicle (block 316), or stated otherwise, for each resident vehicle, the example process continues by checking whether the resident vehicle is still within the geo-fence (block 318). Stated oppositely, the determination is whether the otherwise disabled and resident vehicle has nevertheless relocated outside the geo-fence. If so, the example process sends an alert (block 320) to appropriate entities, and the example process makes a determination as to whether there are further resident vehicles to be checked (block 322). On the other hand, if the particular resident vehicle remains inside the geo-fence (i.e., the yes path out of block 318), the example process moves directly to the determination as to whether there are further resident vehicles to be checked (again block 322). If there are more resident vehicles to be checked, the example process retreats to the determination of block 318 for the next resident vehicle.

If all the resident vehicles have been checked, the next step in the example process is a determination as to whether the time has arrived for de-establishment of the geo-fence (i.e., time to end the geo-fence shown in block 324). If the time has yet to arrive (i.e., the no path out of block 324), the example process retreats to again analyzing the location of the resident vehicles. On the other hand, if the time has arrived to de-establish the geo-fence (i.e., the yes path out of block 324), the example process de-establishes the geo-fence (block 326), and the example method ends (block 328), to begin anew the next evening as determined by the block 304.

The discussion now turns to the case in which the onboard devices are primarily responsible for establishing the geo-fence and taking subsequent actions. In the example, the operations center 100 sends, to each onboard device 116 (FIG. 1) of each vehicle 114 (FIG. 1) identified by the vehicle inventory list, parameters indicating a geo-fence to be established at repeating intervals and at a predetermined time each day. In the evening at the predetermined time, such as after close of business each day, each onboard device 116 compares its location to the boundaries of the geo-fence (i.e., establishes the geo-fence), such as by using a respective mapping module 122. When an onboard device 116 determines the vehicle resides within the geo-fence-a resident vehicle-the onboard device 116 disables its associated vehicle 114, such as by making its relay 126 non-conductive. During periods of time that the geo-fence is established (e.g., overnight), the onboard device 116 continues to monitor its location relative to the geo-fence. If the onboard device 116 and thus the vehicle 114 crosses the geo-fence or otherwise finds itself outside the geo-fence, the onboard device 116 sends an alert to appropriate entities by way of the wireless network interface 124. In some cases, the onboard device 116 sends the alerts directly, and in other cases the onboard device 116 sends the alerts to the operations center 100, which relays the alerts to the appropriate entities.

Still considering the case of the onboard devices 116 being primarily responsible for establishing the geo-fence, when an onboard device determines the vehicle resides outside the geo-fence when the geo-fence is established-a non-resident vehicle-the onboard device 116 refrains from disabling the associated vehicle 114. Moreover, the onboard device 116 may send a message to the operations center 100 indicating that the onboard device 116 is associated with a non-resident vehicle, and the operations center 100 may then be responsible for compiling information from all the onboard devices associated with non-resident vehicles to create the non-resident vehicle list.

Based on the parameters related to the geo-fence received by each onboard device 116, the geo-fence may be disabled at the designated time and/or after the preset duration. For example, early in the morning on the next business day each onboard device 116 may de-establish its geo-fence, and to the extent the onboard device 116 is associated with a resident vehicle, the onboard device 116 may enable its associated vehicle.

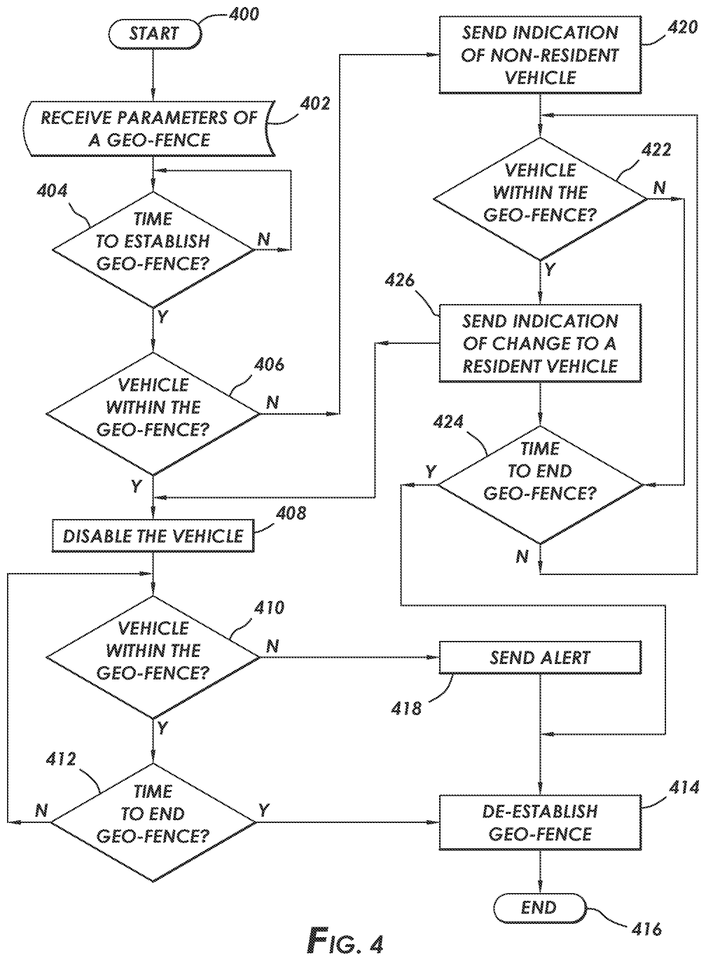

FIG. 4 shows an example flow chart for the case in which the onboard device 116 (FIG. 1) is primarily responsible for establishing the geo-fence, monitoring the vehicle with respect to the geo-fence, and taking or triggering subsequent actions. Thus, the process of FIG. 4 may be implemented by the controller 118 (FIG. 1) of each onboard device 116. In particular, the method starts (block 400), and comprises receiving parameters of a geo-fence (block 402). In the example, the operations center 100 (FIG. 1) may provide the parameters indicating a geo-fence to be established at repeating intervals, a predetermined time each day to establish the geo-fence, and a preset duration or end time for the geo-fence.

The next example step is a determination whether the predetermined time to establish the geo-fence has arrived (block 404). If the time has not yet arrived (again block 404), the example process loops until the predetermined time. If the predetermined time has arrived (again block 404), the example process moves to determining whether the onboard device 116 and thus the vehicle 114 are within the geo-fence (block 406). If the vehicle is within the geo-fence, the vehicle is disabled (block 408), such as by the onboard device 116 making the relay 126 non-conductive. Though the vehicle is disabled, in the example process continues the monitor the location of the onboard device 116 and thus the vehicle (block 410) until the time to end or de-establish the geo-fence (block 412). Thus, so long as the vehicle 114 remains within the geo-fence, the example process loops until the end time arrives. Thereafter, the geo-fence is de-established (block 414) and the process ends (block 416), to begin anew the next evening as determined by the block 404. It is noted that if the parameters of the geo-fence have not changed, there is no need for the operations 100 to re-send the parameters, and thus the receiving step (block 402) may be skipped unless and until there is a change to the parameters.

Returning to the case of the vehicle initially being a resident vehicle and before the geo-fence is de-established. If the onboard device 116 finds itself outside the geo-fence within the duration of the geo-fence (again block 410), the example process sends an alert (block 418). In order not to further complicate the figure, the example flow chart assumes that, if the onboard device 116 of a resident vehicle nevertheless finds itself outside the geo-fence, the vehicle is likely stolen and will not be returned to the geo-fence within the duration of the geo-fence. Thus, in the example process the geo-fence is de-established (block 414) and the methods ends (block 416). However, one having ordinary skill, and with the benefit of this disclosure, could modify the process to accommodate a situation in which a resident vehicle both departs from and returns to the geo-fence boundaries within the duration of the geo-fence.

Returning to the case that initially an onboard device 116 is outside the geo-fence (i.e., the no path from block 406). If the onboard device 116 initially finds itself outside the geo-fence, the example process sends an indication of a non-resident vehicle (block 420) to the operations center 100 and/or to any appropriate entity. In some cases the process may end after sending the indication of the non-resident vehicle, but the example process of FIG. 4 continues to monitor the non-resident vehicle for returning to be within the geo-fence boundary. In particular, after sending the indication of non-resident vehicle (again block 420), the onboard device again determines whether the vehicle is within the geo-fence boundary (block 422). If the vehicle remains outside the geo-fence boundary (again block 422) until the time arrives to end or de-establish the geo-fence (block 424), the example process loops. Once the time arrives to de-establish the geo-fence (again block 424), the example process de-establishes the geo-fence (block 414) and the process ends (block 416).

However, if the onboard device 116 of the initially non-resident vehicle finds itself within the geo-fence (again block 422), the example process sends an indication of a change to a resident vehicle (block 426), and the example onboard device 116 then continues as if the returned vehicle was initially a resident vehicle, by disabling the vehicle (block 408) and continued monitoring (blocks 410 and 412).

The flow chart of FIG. 3 represents a case in which the operations centers 100 performs the bulk the example process, and the onboard devices merely provide data indicative of location. The flow chart of FIG. 4 represents a case in which the onboard device 116 attached to each vehicle performs the bulk of the work, and the operations center 100 contributes by sending the parameter associated with the geo-fence and gathering and handing the non-resident vehicle list. Hybrid implementations are also possible.

Thus, in yet still other cases responsibility for establishing the geo-fence and monitoring may be split between the operations center 100 and the onboard devices 116. For example, the onboard devices 116 may have limited processing ability and/or limited memory, and thus some aspects of the overall method may be implemented at the operations center 100 owing to the limited ability of the onboard devices 116. In one example, the operations center 100 is primarily responsible for monitoring the time and date, and establishing and de-establishing the geo-fence each day at the appropriate times, taking into account closed days and holidays. However, when the operations center 100 determines that it is time to establish the geo-fence, the operations center 100 communicates with the onboard device 116 of each vehicle 114 on the vehicle inventory list, and commands the onboard device 116 of each vehicle 114 to begin monitoring location relative to the geo-fence. The geo-fence information may have previously provided by the operations center to each onboard device 116, or the operations center 100 may send parameters associated with the geo-fence each time the geo-fence is established.

Once established, however, in this example each onboard device 116 is responsible for determining its location relative to the geo-fence. If an onboard device 116 finds itself associated with a resident vehicle inside the geo-fence, the onboard device 116 may disable its associated vehicle by way of relay 126. If the onboard device 116 associated with the resident vehicle determines the resident vehicle relocated outside the geo-fence, the onboard device 116 may send an alert and/or message indicating relocation outside the geo-fence. On the other hand, if the onboard device 116 initially finds itself outside the geo-fence, the onboard device 116 may send a message to the operations center 100 indicating the onboard device 116 is associated with a non-resident vehicle. Compiling the list of non-resident vehicles may thus again be handled by the operations center 100.

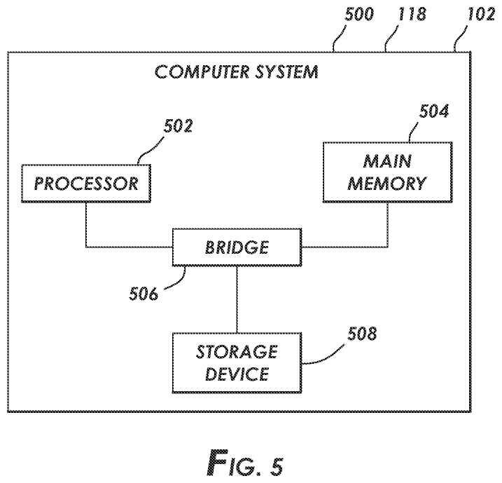

FIG. 5 shows a computer system 500, which is illustrative of a computer system upon which the various embodiments may be practiced. The computer system 500 may be illustrative of, for example, controller 118 of the onboard device 116. In yet another case, computer system 500 may be illustrative of computer system 102. In particular, computer system 500 comprises a processor 502, and the processor is couple to a main memory 504 by way of a bridge device 506. Moreover, the processor 502 may couple to a long term storage device 508 (e.g., a hard drive, solid state disk, memory stick, optical disc) by way of the bridge device 506. Programs executable by the processor 502 may be stored on the storage device 508, and accessed when needed by the processor 502. The program stored on the storage device 508 may comprise programs to implement the various embodiments of the present specification, such as disabling a vehicle if within the geo-fence, and sending an indication of the last known location of vehicle if the vehicle nevertheless crosses the geo-fence. In some cases, the programs are copied from the storage device 508 to the main memory 504, and the programs are executed from the main memory 504. Thus, the main memory 504, and storage device 508 shall be considered computer-readable storage mediums.

From the description provided herein, those skilled in the art are readily able to combine software created as described with appropriate general-purpose or special-purpose computer hardware to create a computer system and/or computer sub-components in accordance with the various embodiments, to create a computer system and/or computer sub-components for carrying out the methods of the various embodiments and/or to create a non-transitory computer-readable medium (i.e., not a carrier wave) that stores a software program to implement the method aspects of the various embodiments.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer-implemented method of vehicle inventory control, the method comprising:
receiving parameters indicating a geo-fence to be established at a predetermined time;
establishing the geo-fence at the predetermined time;
disabling a resident vehicle identified on a predetermined list of vehicles, the resident vehicle within the geo-fence at the predetermined time; and
refraining from disabling a non-resident vehicle identified on the predetermined list of vehicles that is outside the geo-fence at the predetermined time.

2. The computer-implemented method of claim 1:
wherein receiving parameters further comprises receiving parameters indicative of a duration of establishment of the geo-fence; and further comprising enabling the resident vehicle after the duration.

3. The method of claim 1 further comprising:
determining the resident vehicle relocated outside the geo-fence; and
sending an alert responsive to the resident vehicle being outside the geo-fence.

4. The method of claim 3 wherein determining the resident vehicle is outside the geo-fence further comprises determining by way of a computer system located at an operations center remote from the location of the geo-fence.

5. The method of claim 3 wherein determining the resident vehicle relocated outside the geo-fence further comprises determining by way of an onboard device mechanically and electrically coupled to the resident vehicle.

6. The method of claim 3 wherein sending the alert further comprises sending the alert to at least one selected from the group consisting of: an owner of the resident vehicle; a consignor of the resident vehicle; a holder of a lien against the resident vehicle; and a law enforcement officer.

7. The method of claim 1 further comprising:
compiling a list of non-resident vehicles identified on the predetermined list of vehicles that are outside the geo-fence when the geo-fence is established; and
sending the list to at least one selected from a group comprising: an owner of the non-resident vehicles; a consignor of the non-resident vehicles; and a holder of a lien against the non-resident vehicles.

8. A system comprising:
a processor;
a wireless interface coupled to the processor;
a memory coupled to the processor, the memory storing a program that, when executed by the processor, causes the processor to:
receive parameters indicative of boundaries of a geo-fence to be established at repeating intervals and a predetermined time each day to establish the geo-fence;
establish the geo-fence at the predetermined time;
disable a resident vehicle identified on a predetermined list of vehicles, the resident vehicle within the geo-fence; and
refrain from disabling a non-resident vehicle identified on the predetermined list of vehicles that is outside the geo-fence.

9. The system of claim 8:
wherein when the processor receives the parameters, the program further causes the processor to receive parameters indicative of a duration of establishment of the geo-fence; and wherein the program further causes the processor to enable the resident vehicle after the duration.

10. The system of claim 8 wherein the program further causes the processor to:
determine the resident vehicle relocated outside the geo-fence; and
send an alert responsive to the resident vehicle being outside the geo-fence.

11. The system of claim 10 wherein when the processor determines the resident vehicle is outside the geo-fence, the program further causes the processor to:
receive location data from an onboard device mechanically and electrically coupled to the resident vehicle; and
determine from the location data and the parameters indicative of the boundaries of the geo-fence that the resident vehicle relocated outside the geo-fence.

12. The system of claim 10 wherein the processor, the wireless interface, and the memory are members of a controller of an onboard device mechanically and electrically coupled to the resident vehicle.

13. The system of claim 10 wherein when the processor sends the alert, the program further causes the processor to send the alert to at least one selected from the group consisting of: an owner of the resident vehicle; a consignor of the resident vehicle; a holder of a lien against the resident vehicle; and a law enforcement officer.

14. The system of claim 8 wherein the program further causes the processor to:
compile a list of non-resident vehicles identified on the predetermined list of vehicles that are outside the geo-fence when the geo-fence is established; and
send the list to at least one selected from a group comprising: an owner of the non-resident vehicles; a consignor of the non-resident vehicles; and a holder of a lien against the non-resident vehicles.

15. A non-transitory computer-readable medium storing instructions that, when executed by a processor, cause the processor to:
receive parameters indicative of boundaries of a geo-fence to be established at repeating intervals, the parameters indicative of a preset duration for each geo-fence, and the parameters indicative of a predetermined time each day to establish the geo-fence;
establish the geo-fence at the predetermined time, the geo-fence established for the preset duration;
disable a resident vehicle identified on a predetermined list of vehicles, the resident vehicle within the geo-fence at the predetermined time, and the resident vehicle disabled for the preset duration; and
refrain from disabling a non-resident vehicle identified on the predetermined list of vehicles that is outside the geo-fence when the geo-fence is established.

16. The non-transitory computer-readable medium of claim 15:
wherein when the processor receives the parameters, the instructions further cause the processor to receive parameters indicative of a duration of establishment of the geo-fence; and wherein the instructions further cause the processor to enable the resident vehicle after the duration.

17. The non-transitory computer-readable medium of claim 15 wherein the instructions further causes the processor to:
determine the resident vehicle relocated outside the geo-fence; and
send an alert responsive to the resident vehicle being outside the geo-fence.

18. The non-transitory computer-readable medium of claim 17 wherein when the processor determines the resident vehicle is outside the geo-fence, the instructions further causes the processor to:
receive location data from an onboard device mechanically and electrically coupled to the resident vehicle; and
determine from the location data and the parameters indicative of the boundaries of the geo-fence that the resident vehicle relocated outside the geo-fence.

19. The non-transitory computer-readable medium of claim 17 wherein when the processor sends the alert, the instructions cause the processor to send the alert to at least one selected from a group consisting of: an owner of the resident vehicle; a consignor of the resident vehicle; a holder of a lien against the resident vehicle; and a law enforcement officer.

20. The non-transitory computer-readable medium of claim 15 wherein the instructions further causes the processor to:
compile a list of non-resident vehicles identified on the predetermined list of vehicles that are outside the geo-fence; and
send the list to at least one selected from a group comprising: an owner of the non-resident vehicles; a consignor of the non-resident vehicles; and a holder of a lien against the non-resident vehicles.

21. An onboard device configured to mechanically and electrically couple to a vehicle, the onboard device comprising:
a controller;
a relay defining a set of terminals and a control input, the control input coupled to the controller;
a Global Positioning System receiver coupled to controller;
a wireless interface coupled to the controller;
the controller configured to:
receive parameters indicating boundaries of a geo-fence to be established;
establish the geo-fence;
disable the vehicle by asserting the control input of the relay if the vehicle is within the geo-fence; and
refrain from disabling by holding the control input de-asserted if vehicle is outside the geo-fence.

22. The onboard device of claim 21:
wherein when the controller receives the parameters, the controller further receives the parameters indicative of repeating intervals for the geo-fence; and
wherein when the controller establishes the geo-fence, the controller is further configured to establish the geo-fence at the repeating intervals.

23. The onboard device of claim 21 wherein when the controller disables the vehicle, the controller is further configured to:
determine the vehicle relocated outside the geo-fence; and
send an alert responsive to the vehicle being outside the geo-fence.
